(19) United States
(12) Patent Application Publication
(10) Pub. No.: US 2006/0004806 A1
(43) Pub. Date: Jan. 5, 2006

(54) Updating data in a multi-system network that utilizes asynchronous message transfer

(76) Inventor: Frank Michael Kraft, Speyer (DE)

Correspondence Address: FISH & RICHARDSON, P.C., PO BOX 1022, MINNEAPOLIS, MN, 55440-1022, US

(21) Appl. No.: 10/858,221

(22) Filed: Jun. 1, 2004

(51) Int. Cl. G06F 17/00

(52) U.S. Cl. 707/101

(57) ABSTRACT

Techniques are provided for updating a locally stored version of a data set in a multiple-system environment where each system maintains a separate stored version of the data set and is capable of modifying the data set. A data set stored locally in a first application system is modified and a message is generated containing a modification value and the first application system's modified data set. The message is sent to a second application system that also maintains a version of the data set. The second application system compares its locally-stored data set to the data set of the message. Based on the results of the comparison, the second application system either replaces a data value in its locally-stored data set with a data value in the message or adds the modification value in the message to the data value in its data set.

### TECHNICAL FIELD

This invention relates to asynchronous data transfer between different computing systems, and more particularly to techniques for updating data that is maintained and modified by two or more computing systems in a multiple-system environment where asynchronous messaging is employed.

### BACKGROUND

A multiple-system network may include two or more systems that share a common data set. The multiple systems may share the data set by maintaining a local version of the data set in a local database. In some networks, each of the multiple systems may modify or change the data set by making changes to the system's local version of the data set and then communicating the changes to the other systems in the network. The messages allow the other systems to update their local data set with the modifications that occurred in other systems so that the data sets of the various systems are consistent and the integrity of the data set is maintained.

In some networks, the systems communicate changes to the data set via asynchronous messaging. Because asynchronous messaging may be used to update the various data sets in the network, it is possible that messages between the systems could be delayed or even lost. In the event of a lost message, a state of equilibrium between the data sets of the systems may not be reached. Further, in networks where the systems make frequent changes to the data set, the large number of update messages being communicated by the systems may burden the network. The burden increases in networks where the update messages contain a large amount of data.

### SUMMARY

The invention provides techniques for updating a locally stored version of a data set, wherein multiple application systems each maintain a separate stored version of the data set and are capable of modifying the data set. The data set comprises a data value and a change value for each of the multiple application systems that indicates the most recent modification from the respective application system that has been reflected in the data value.

In an aspect, the invention provides a method for performing such an update. In the method, a message from a first application system of the multiple application systems is received at a second application system of the multiple application systems. The message contains the data set as locally stored in the first application system and a modification value that indicates a modification made to the data set as locally stored in the first application system. For each change value in the received message, the change value of the data set stored locally in the second application system is compared with the corresponding change value in the received message. If the comparison indicates that the change value for the first application system in the message is more recent than the corresponding change value in the data set of the second application system and that the change values for all other application systems in the message are equal to the change values for the corresponding application systems in the data set of the second application system, the data value in the data set of the second application system is replaced with the data value in the received message. If otherwise, then the modification in the message is added to the data value in the data set of the second application system.

In embodiments, the replaced data value in the data set of the second application system may be compared to the data value that would result from the addition of the modification in the message to the data value in the data set of the second application system before replacing the data value in the data set of the second application system with the data value in the message. If the replaced data value in the data set of the second application system is not equal to the result of the addition of the modification in the message to the data value in the data set of the second application system before replacing the data value in the data set of the second application system with the data value in the message, the data set of the second application system may be corrected. In another embodiment, the second application system may indicate to the multiple application systems that the data set of the second application system contains an error if the replaced data value in the data set of the second application system is not equal to the result of the addition of the modification in the message to the data value in the data set of the second application system before replacing the data value in the data set of the second application system with the data value in the message.

In another aspect, the invention provides a method for updating a locally stored version of a data set. In the method, a data set stored locally in a first application system is modified. A message is generated containing the modification to the data set of the first application system and the modified data set as locally stored in the first application system. The message is sent to a second application system that maintains a version of the data set.

In embodiments, the methods may have one or more of the following features. The first application system may send messages to the second application system after each modification to the data set of the first application system. The messages may be sent from the first application system to the second application system using asynchronous message transfer. In some implementations, the change values may be a timestamp that indicates the time of the modification to the data set. In other implementations, the change value may be a version number that is incremented after each modification to the data set.

In other aspects, the invention provides computer program products that perform the above-described methods. In particular, the program products comprise executable instructions tangibly embodied on an information carrier.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a multiple system network in which a data set is maintained and modified by the multiple systems.

FIG. 2 is a diagram showing an example protocol for a message that may be transferred between the systems of FIG. 1.

FIG. 3 is a block diagram of a computer system that may be included in the systems of FIG. 1.

FIGS. 4A and 4B show a flowchart of a method of updating a data set of a system shown in FIG. 1.

FIG. 5 is a table that illustrates a method of updating the data sets of the multiple systems shown in FIG. 1.

Like reference symbols in the various drawings indicate like elements.

### DETAILED DESCRIPTION

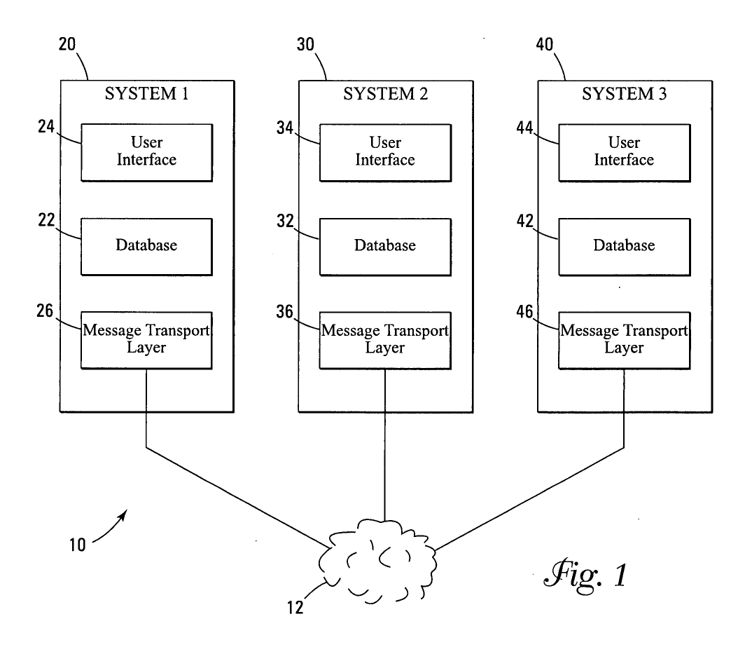

A multi-system network 10, shown in FIG. 1, includes three networked computing systems, which in this example are a first system 20, a second system 30, and a third system 40. The systems 20, 30, and 40 each maintain a data set that is shared by the systems in the network 10. Each system's data set includes a data value and multiple change values that correspond to each system in the network 10. The change values track the modifications or changes that are made to the data set by the various systems in the network 10. For each modification made by one of the systems 20, 30, or 40 to the data set, the modifying system sends an asynchronous message containing the system's data set and other information to the other systems in the network 10, as will be described later. When a system receives the message, the system compares the change values in the received message to the corresponding change values in the system's local data set. If the change values indicate that the modification has not been reflected in the receiving system's data set, the system updates its local data with the modification in the message. By comparing the change values in the message to the change values in the receiving system's local data set, any inconsistencies that may exist among the data sets of the multiple systems in the network 10 may be repaired.

The first system 20 includes a database 22, a user interface 24, and a message transport layer 26. The database 22 contains the system's local version of the data set that is shared by the various systems 20, 30, and 40 in the network 10. In the FIG. 1 example, the data set relates to products or inventory information and may be used to track quantities of items that are purchased, sold, returned, etc. In other examples, the data set may relate to banking information, accounting information, or other types of information that may be maintained using the methods described herein.

The data set in this example includes a data value and a corresponding change value for each of the systems in the network. The change value may be, for example, a version number that is incremented after each change or modification of the data value. Alternatively, the change value may be a timestamp that reflects the actual time of the modification. Yet in other implementations, a different non-cyclical identifier may be used to track the changes to the data value.

The data value in the data set may be changed or modified through the user interface 24. These changes may be made by a system administrator accessing the first system 20 or, alternatively, by other systems in the network that are authorized by making these modifications. When the data value is modified in a database 22, the first system 20 sends a message to the other systems 30 and 40 to update their respective versions of the data set. In this example, the messages are sent to the other systems asynchronously; however, the messages may also be transmitted between the systems using other suitable methods. These messages are sent to other systems in the network through message transport layer 26. The message transport layer 26 also receives messages from other systems. In this example, a network 12 connects the first system 20, the second system 30, and the third system 40. The network may be a LAN, the Internet, or another suitable network.

In the FIG. 1 example, the second system 30 and the third system 40 are similar to the first system 20. The systems 30 and 40 include databases 32 and 42 that store each system's version of the data set, user interfaces 34 and 44 through which each system may modify its data set, and messages transport layers 36 and 46 to send and receive messages.

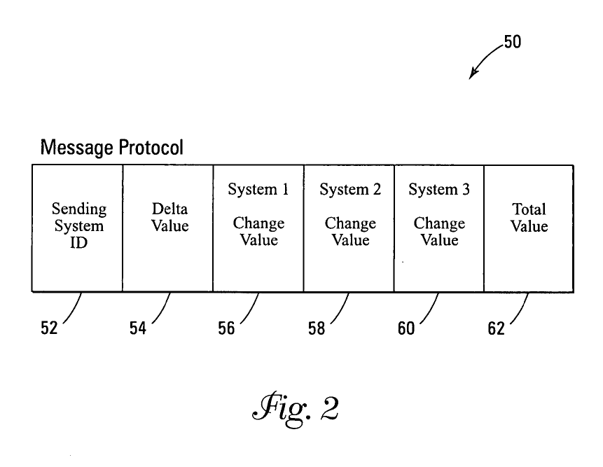

FIG. 2 is a diagram of an example message format that may be used for messages transferred between the systems 20, 30, and 40 of FIG. 1. The message 50 includes a sending system identifier 52, which identifies the system from which the message is being sent. A delta value 54, which may also be referred to as a modification value, is also included in the message 50. The delta value 54 indicates the value of the change that was made to the sending system's data set that prompted the generation of the message 50. For example, the delta value would be +3 if the sending system modifies the data set from two to five.

The message 50 also includes a first system change value 56, a second system change value 58, and a third system change value 60. The change values 56, 58, and 60 correspond to the modifications made by the sending system to its data set in response to modifications from the various systems in the network. The change values 56, 58, and 60 allow the system receiving the message 50 to determine how to process the message and, if required, how to modify its data set, as discussed in greater detail later. The message also includes a total value 62. In the FIG. 1 example, the total value 62 is the latest data value in the sending system and reflects the modifications of the other systems in the network that have been received and processed by the sending system. In other examples, the total value 62 may represent other information or may be omitted.

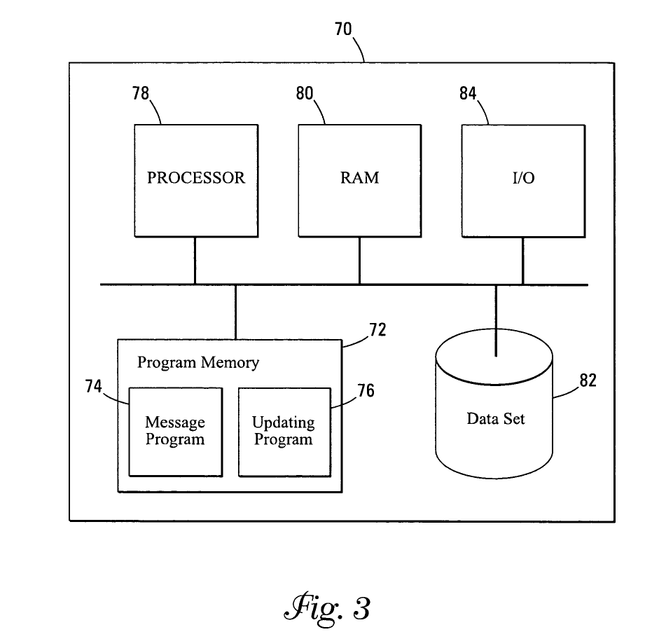

FIG. 3 is a block diagram of a computer system 70 that may be included in the systems 20, 30, and 40 of FIG. 1. The computer system 70 includes program memory 72 that contains a message program 74 and an updating program 76. The message program 74 contains instructions that, when loaded into RAM 80 and executed by a processor 78, generate a message for transmission to another system in the network, for example, the message 50 shown in FIG. 2. The processor may obtain the information in the FIG. 2 message from the system's data set 82. The message may then be stored in RAM 80 until it is output by an input/output module 84 to a message transport layer (shown in FIG. 1). Messages may also be received through the input/output module 84 and stored in RAM 80 for processing. The updating program 76 contains instructions that, when loaded into RAM 80 and executed by the processor 78, processes the received messages stored in RAM 80 and, if necessary, updates the data value and change values stored in the data set 82.

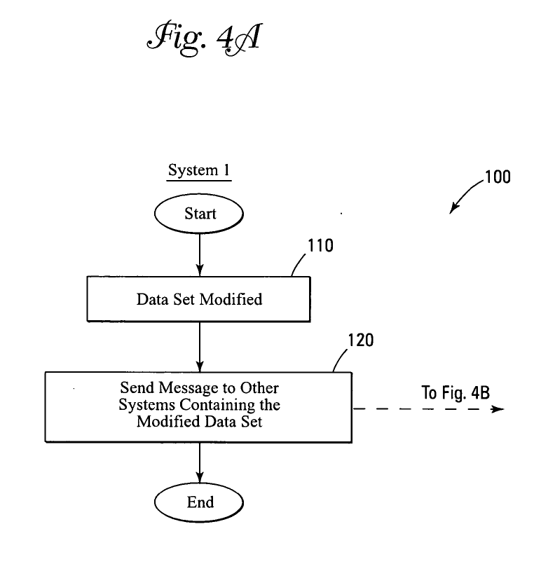

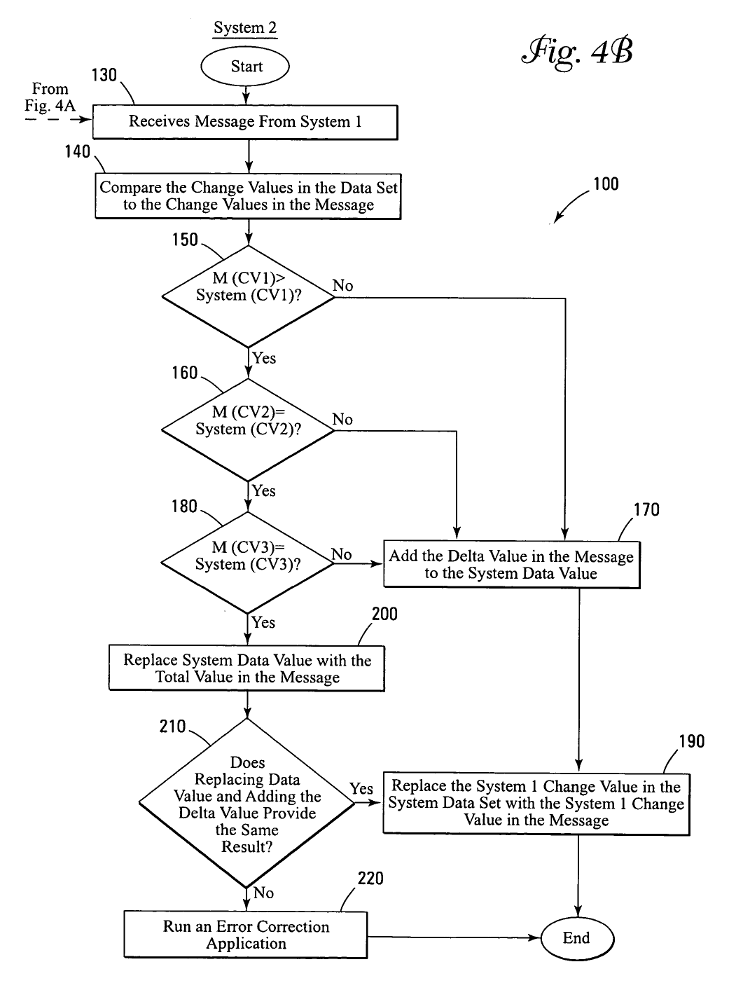

FIGS. 4A and 4B show a flowchart of a method 100 of updating a data set of a system in a network. In this example, the changes in the various systems are communicated to other systems in the network using asynchronous messaging. As a consequence, messages may be delayed so that more recent update messages are received and processed by a receiving system before older messages are received and processed. In addition, changes may be made by a receiving system to its data set during a message delay, also called a concurrent change. Using the method 100, the receiving system can determine whether a message delay or concurrent change has occurred, and after such a determination, process the message in a manner that maintains the integrity of its data set. The method 100 also allows the receiving system to detect errors in its data set and make the necessary repairs.

In networks that contain a large number of systems or where the systems modify the data set on a frequent basis, the modifying systems may create a large number of update messages for transmission between the various systems. In some networks, the high volume of messages may burden the network. This problem is increased in networks where the update messages contain a large amount of data. The method 100 provides a technique for maintaining and repairing data sets using a minimal amount of data. For example, the FIG. 2 message includes an identification of the system sending the message, the change made by the system (the delta or modification value), change values for the each system in the network, and the sending system's current data value.

In the example method 100, the systems in the network process an update message by comparing the change values in the message with the change values in the receiving system's data set. If the comparison indicates that the message change values and the corresponding change values in the receiving system's data set are equal for all systems, except for the system from which the message was sent, the receiving system replaces its data value with the total value in the message (i.e., the sending system's data value). The receiving system may also add the delta value (i.e., the modification made by the sending system) to the receiving system's data value, as this operation should achieve the same result as the replacement of the data value. If comparison indicates that the change values in the message and in the receiving system's data set are not equal for all systems except for the sending system, then the receiving system updates its data set by adding the delta value in the message. The FIGS. 4A and 4B illustrate the method 100 using the example of FIG. 1.

Referring to FIG. 4A, the method 100 begins at step 110 with the modification of a first system's data set, as described previously. Next, at step 120, the first system 20 sends an asynchronous message to the other systems 30 and 40 that contains the update information, for example, the information shown in message 50 of FIG. 2. In some examples, the message may include additional information, and in other examples, the some of the message components may be omitted.

Referring to FIG. 4B, the second system 30 receives the update message sent by the first system 20 at step 130. After the message is received, the second system 30 compares the change values in the message with the corresponding change values in the second system's data set at step 140. If the second system 30 determines at step 150 that the change value in the message that corresponds to the first system 20 is greater, or more recent, than the change value for the first system 30 in the second system's data set, then the second system 30 proceeds to step 160. However, if the second system 30 determines that the change value for the first system 20 in the message is not more recent than the change value in the second system's data set, then the received message has been delayed. In that case, second system 30 adds the delta value in the message to its data value at step 170.

Similarly, if the second system 30 determines at step 160 that the change value for the second system in the message is equal to the corresponding change value in its data set, the second system 30 proceeds to step 180 to compare the change values in the message and the second system's data set for the third system 40. If at step 160 or at step 180, the second system 30 determines that the change values are not equal, then the second system 30 proceeds to step 170 and adds the delta value in the message to the second system's data value. After the second system data value has been updated by adding the delta value, at step 190 the second system 30 replaces the change value for the first system in its data set with the corresponding change value in the message.

If the second system 30 determines that the change values are equal at step 180, then the second system 30 replaces the data value in its data set with the total value in the received message at step 200. In some implementations, the total value may be omitted from the update message. In such an example, the receiving system's data set may be updated by adding delta value to the data value (step 170) in all circumstances.

At step 210, the second system 30 compares the results of the update at step 200 with the update that would result from adding the delta value in the message to the second system's data value, as performed at step 170. If the update achieved by replacing the data value with the total value in the message and the update that results from adding the delta value are not the same, then there may be an error in the second system's data set. If an error exists, the second system executes an error correction application to repair the data set at 220. The error correction application may be, for example, a software program that, when executed, stops all modifications to the data set and corrects the data sets. In other examples, the second system 30 may raise a flag indicating that an error exists, rather than running an error correction application. If the update performed at step 200 and the addition of the delta value in the message to the second system's data value would yield the same result, the second system proceeds to step 190 and replaces the change value for the first system in its data set with the corresponding change value in the message. In other implementations, the step 210 comparison may be omitted.

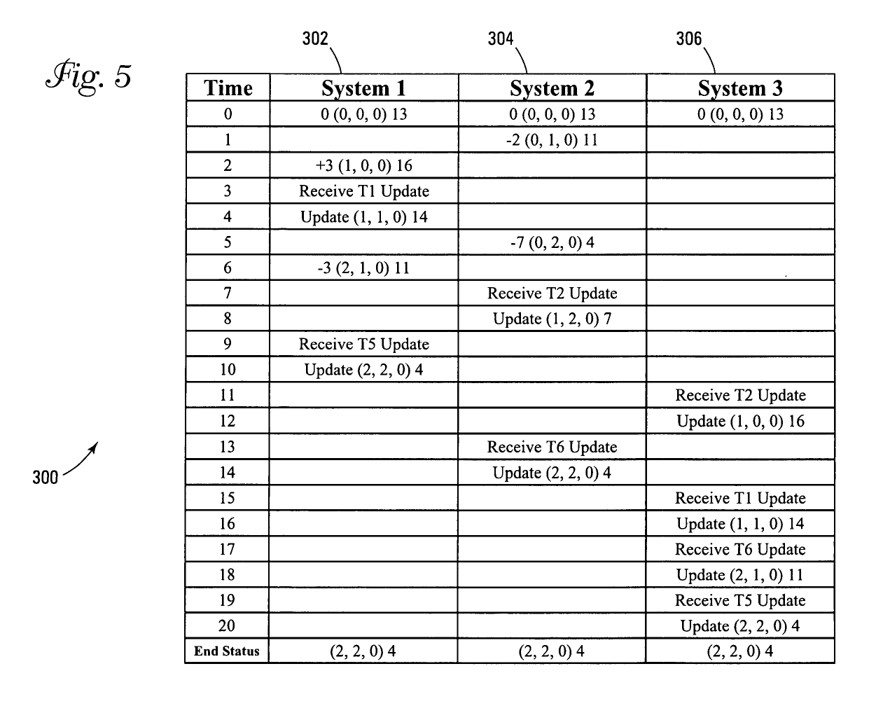

FIG. 5 is a table that illustrates the method of updating the data set of a system in a network shown in FIGS. 4A and 4B. The table 300 includes three columns, 302, 304, and 306 that correspond to the first system 20, the second system 30, and third system 40 of FIG. 1, respectively. Each row of the table 300 represents a time period from T0 to T20. The contents of the data sets in the columns 302, 304, and 306 are shown in a format +A (B, C, D) E. In this example, the +A represents the delta value. The change value vector (B, C, D) represents the first system change value (B), the second system change value (C), and the third system change value (D). The change value in this example is a version number that is incremented after each modification to the data set by the corresponding system. Thus, in this example, a higher change value number indicates that the corresponding data value is more recent. The E represents a system's data value, and in the examples where the data relates to a message, the E represents the total value.

At T0, the contents of the data sets for the systems are in a state of equilibrium at (0, 0, 0) 13. At T1, the data set of the second system in column 304 is modified by the subtraction of two units of inventory. The contents of the second system's data set is changed to (0, 1, 0) 11, which indicates that the second system's data value is 11 and its change value is one. After modification of the second system's data set, the second system sends an asynchronous message to the other systems containing the modified data set, as discussed previously.

At T2, the first system's data set is modified by the addition of three units of inventory. The contents of the first system's data set is changed to (1, 0, 0) 16, which indicates that the first system's data value is 16 and the its change value is one. After the modification, the first system sends an asynchronous message to the other systems containing the modified data set.

At T3, the first system receives the T1 message −2 (0, 1, 0) 11 containing the second system's modified data set. In the FIG. 5 example, the update messages include the sender identifier (not shown in the table), the delta value, the change values, and the data value. In accordance with the method of FIGS. 4A and 4B, the first system compares the change values of the message to the corresponding change values of the first system's data set. The comparison reveals that first system change value in the message (0) is not equal to the corresponding change value of the first system data set (1). Therefore, the first system adds the delta value in the message to the data value in its data set. The corresponding first system change value is also replaced. After the update at T4, the contents of the first system data set are (1, 1, 0) 14.

At T5, the data set of the second system is modified with the subtraction of seven units of inventory. With this modification, the second system's data set is changed to (0, 2, 0) 4. At T6, the data set of the first system is modified with the subtraction of three units of inventory. The first system's data set is changed to (2, 1, 0) 11. After the modifications, both systems send their modified data set to the other systems in the network.

At T7, the second system receives the T2 message +3 (1, 0, 0) 16 containing the first system's modified data set. The change values in the message are compared to the change values in the second system. The comparison shows that second system change value in the message (0) is less recent and not equal to the corresponding change value of the second system data set (2). Therefore, the second system adds the delta value in the message to the data value in its data set. The corresponding first system change value is also replaced. After the update at T8, the contents of the second system data set are (1, 2, 0) 7.

At T9, the first system receives the T5 message −7 (0, 2, 0) 4 containing the second system's modified data set. The first system change values and the message change values are compared. The comparison indicates that the change value in the message (0) is not equal to the corresponding change value in the first system data set (2). Accordingly, the first system adds the delta value in the message to its data value, and replaces the corresponding second system value in its data set. At T10, the contents of the first system data set are (2, 2, 0) 4.

At T11, the third system receives the T2 message +3 (1, 0, 0) 16. As described previously, the change values are compared and indicate that the change values for the second and third systems in the message are equal to the change values in the third system's data set.

Thus, the third system replaces the third system's data value with the total value in the message (16). The third system may also compare the third systems modified data value with the result achieved by adding the message delta value, as shown at step 210 of FIG. 4B. Here, replacing the total and adding the delta value lead to the same result, which indicates that there is no error in the data set. At T12, the contents of the third system's data set are (1, 0, 0) 16.

At T13, the second system receives the T6 message −3 (2, 1, 0) 11. The comparison of the change values shows that the change value for the second system in the second system's data set (2) is not equal to the corresponding change value in the message (1). The second system adds the delta value in the message to its data value, and replaces the corresponding change value in its data set. At T14, the contents of the second system data set are (2, 2, 0) 4.

At T15, the third system receives the T1 message −2 (0, 1, 0) 11. The comparison of the change values shows that the system one change value in the system three data set (1) is not equal to the system one change value in the message (0). Thus, the third system adds the message delta value to its data value and replaces the corresponding change value in its data set. At T16, the contents of the third system data set is (1, 1, 0) 14.

At T17, the third system receives the T6 message −3 (2, 1, 0) 11. The change value comparison indicates that the change values for the second and third system in the third system data set are equal to the corresponding change values in the message. Therefore, the third system replaces its data value with the total value (11) in the message. The third system may also compare this result to the addition of the message delta value, which are equal and indicate that there is no error in the data set. At T18, the contents of the third system data set are (2, 1, 0) 11.

At T19, the third system receives the T5 message −7 (0, 2, 0) 4. The change value comparison shows that the first system change value in the data set (2) is not equal to the first system change value in the message (0). The message delta value is added to the third system data value, and the corresponding change value is replaced. At T20, the contents of the third system data set are (2, 2, 0) 4. After this modification, the data sets of the three systems are in equilibrium as shown in the last row of table 300 labeled “End Status.”

A number of embodiments of the invention have been described. Nevertheless, it will be understood that various modifications may be made without departing from the spirit and scope of the invention. For example, the method of updating the data sets of the systems is applicable to networks with more than three systems. The method may also be used in networks that may develop inconsistencies between the various system data sets, but do not employ asynchronous messaging.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

Accordingly, other embodiments are within the scope of the following claims.

What is claimed is:

1. A method of updating a locally stored version of a data set, wherein multiple application systems each maintain a separate stored version of the data set and are each capable of modifying the data set, wherein the data set comprises a data value and a change value for each of the multiple application systems that indicates the most recent modification from the respective application system that has been reflected in the data value, the method comprising:
receiving, from a first application system of the multiple application systems and at a second application system of the multiple application systems, a message containing 1) the data set as locally stored in the first application system, and 2) a modification value that indicates a modification made to the data set as locally stored in the first application system; and
for each change value in the received message, comparing the change value of the data set stored locally in the second application system with the corresponding change value in the received message; and
if the comparison indicates that the change value for the first application system in the message is more recent than the corresponding change value in the data set of the second application system and that the change values for all other application systems in the message are equal to the change values for the corresponding application systems in the data set of the second application system, then replacing the data value in the data set of the second application system with the data value in the received message; and if otherwise, then adding the modification in the message to the data value in the data set of the second application system.

2. The method of claim 1 further comprising comparing the replaced data value in the data set of the second application system with the data value that would result from the addition of the modification in the message to the data value in the data set of the second application system before replacing the data value in the data set of the second application system with the data value in the message.

3. The method of claim 2 further comprising correcting the data set of the second application system if the replaced data value in the data set of the second application system is not equal to the result of the addition of the modification in the message to the data value in the data set of the second application system before replacing the data value in the data set of the second application system with the data value in the message.

4. The method of claim 2 further comprising indicating to the multiple application systems that the data set of the second application system contains an error if the replaced data value in the data set of the second application system is not equal to the result of the addition of the modification in the message to the data value in the data set of the second application system before replacing the data value in the data set of the second application system with the data value in the message.

5. The method of claim 1 wherein the first application system sends messages to the second application system after each modification of the data set of the first application system.

6. The method of claim 5 wherein the first application system uses asynchronous message transfer to send the messages to the second application system.

7. The method of claim 1 wherein the change value is a timestamp that indicates the time of the modification to the data set.

8. The method of claim 1 wherein the change value is a version number that is incremented after each modification to the data set.

9. A method of updating a locally stored version of a data set, wherein multiple application systems each maintain a separate stored version of the data set and are each capable of modifying the data set, wherein the data set comprises a data value and a change value for each of the multiple application systems that indicates the most recent modification from the respective application system that has been reflected in the data value, the method comprising:
modifying the data value of a data set stored locally in a first application system;
generating a message containing the modification to the data set of the first application system and the modified data set as locally stored in the first application system; and
sending the message to a second application system that maintains a version of the data set.

10. The method of claim 9 wherein the first application system generates the message and uses asynchronous message transfer to send the message to the second system.

11. The method of claim 9 wherein the first application system sends a message to the second application system containing the modification to the data set of the first application system and the modified data set as locally stored in the first application system after each modification to the data set of the first application system.

12. The method of claim 9 wherein the change value is a timestamp that indicates the time of the modification of the data set of the first application system.

13. In a multiple system environment wherein each of the multiple application systems maintain a separate stored version of a data set and are each capable of modifying the data set, the data set comprising a data value and a change value for each of the multiple application systems that indicates the most recent modification from the respective application system that has been reflected in the data value, a computer program product tangibly embodied on an information carrier comprising executable instructions that when executed cause a receiving application system in the multiple-system environment to:
receive, from a sending application system, a message containing 1) the data set as locally stored in the sending application system, and 2) a modification value that indicates a modification made to the data set as locally stored in the sending application system; and
for each change value in the received message, compare the change value of the data set stored locally in the receiving application system with the corresponding change value in the received message; and
if the comparison indicates that the change value for the sending application system in the message is more recent than the corresponding change value in the data set of the receiving application system and that the change values for all other application systems in the message are equal to the change values for the corresponding application systems in the data set of the receiving application system, then replace the data value in the data set of the receiving application system with the data value in the received message; and if otherwise, then add the modification in the message to the data value in data set of the receiving application system.

14. The computer program product of claim 13 further causing the receiving application system to compare the replaced data value in the data set of the receiving application system with the data value that would result from the addition of the modification in the message to the data value in the data set of the receiving application system before replacing the data value in the data set of the receiving application system with the data value in the message.

15. The computer program product of claim 14 further causing the receiving application system to correct the data set of the receiving application system if the replaced data value in the data set of the receiving application system is not equal to the result of the addition of the modification in the message to the data value in the data set of the receiving application system before replacing the data value in the data set of the receiving application system with the data value in the message.

16. The computer program product of claim 14 further causing the receiving application system to indicate to the multiple application systems that the data set of the receiving application system contains an error if the replaced data value in the data set of the receiving application system is not equal to the result of the addition of the modification in the message to the data value in the data set of the receiving application system before replacing the data value in the data set of the receiving application system with the data value in the message.

17. The computer program product of claim 13 wherein the sending application system sends messages to the receiving application system after each modification of the data set of the sending application system.

18. The computer program product of claim 13 wherein the sending application system uses asynchronous message transfer to send the messages to the receiving application system.

19. The computer program product of claim 13 wherein the change value is a timestamp that indicates the time of the modification to the data set.

20. The computer program product of claim 13 wherein the change value is a version number that is incremented after each modification to the data set.
